(19) United States
(12) Patent Application Publication
(10) Pub. No.: US 2019/0005843 A1
(43) Pub. Date: Jan. 3, 2019

(54) System, Method and Apparatus for Online Gaming for Managing Addictions and Building Habits

(71) Applicant: Conquered Self, LLC, Houston, TX (US)

(72) Inventor: Pierce Franklin, Houston, TX (US)

(21) Appl. No.: 15/996,351

(22) Filed: Jun. 1, 2018

Related U.S. Application Data
(60) Provisional application No. 62/514,005, filed on Jun. 1, 2017.

(51) Int. Cl. G09B 19/00; A63F 13/35; A63F 13/85

(52) U.S. Cl. CPC G09B 19/00; A63F 13/85; A63F 13/35

(57) ABSTRACT

A system and method of providing social accountability and support system that may be implemented in a computer gaming environment for overcoming user's addictions, self-doubts, chronic mental disorders or other negative habits or to embed new positive habits such as a healthy diet, improved physical exercise, meditation.

### CROSS REFERENCE TO RELATED APPLICATIONS

This application claims priority from U.S. Provisional Patent Application No. 62/514,005 filed on Jun. 1, 2017 and entitled “System, Method and Apparatus for Online Gaming for Managing Addictions,” which is incorporated herein by reference in its entirety for all purposes.

### FIELD OF THE DISCLOSURE

The present disclosure relates generally to computer gaming, and more particularly, to systems, methods and apparatus for overcoming addictions and reinforcing desirable habits.

### BACKGROUND

Many people suffer from addictions, self-doubts, chronic mental disorders and similar internal conflicts and undesirable habits that often prevent an individual from achieving their potential and can otherwise negatively interfere with the individual's lifestyle. There are many different approaches to managing these addictions, self-doubts, chronic mental disorders and similar internal conflicts and undesirable habits including medication and various 12-step type, addiction recovery programs, and combinations thereof. One such example of the addiction recovery programs is the well-known Alcoholics Anonymous or AA. There are many other, at least somewhat similar to AA, addiction recovery programs.

The addiction recovery programs' success is based on a two-pronged approach of providing psychological and life counseling and also providing assistance to the individuals in the form of positive peer pressure, in a group session. The group sessions are held according to a specific, regular schedule and location. The specific, regular schedule and location provides elements of structure and organization to the individuals' daily lives. However, the logistical requirements of attending a group session at the specific, regular schedule and location can prevent a given individual from participating in an addiction recovery program.

It is in this context that the following embodiments arise.

### SUMMARY

Broadly speaking, the present disclosure provides a positive peer pressure support system that is not tied to a location or a specific time of day through an on-line social setting in the form of a gaming application. The gaming application provides a common interest and environment for interactions between members to provide the positive peer pressure portion of the 12-step-type programs and further provides incentives and accountability for each participating individual. It should be appreciated that the present disclosure can be implemented in numerous ways, including as a process, an apparatus, a system, computer readable media, or a device. Several inventive embodiments of the present disclosure are described below.

One embodiment provides a social accountability and support system for overcoming user's addictions, self-doubts, chronic mental disorders or other negative habits or to embed new positive habits such as a healthy diet, improved physical exercise, meditation.

Another embodiment provides an online gaming environment to engage users and assist user is overcoming addictions, self-doubts, chronic mental disorders or other negative habits or to embed new positive habits such as a healthy diet, improved physical exercise, meditation.

Other aspects and advantages of the disclosure will become apparent from the following detailed description, taken in conjunction with the accompanying drawings, illustrating by way of example the principles of the disclosure.

### BRIEF DESCRIPTION OF THE DRAWINGS

The present disclosure will be readily understood by the following detailed description in conjunction with the accompanying drawings.

FIG. 1A is a block diagram of the social accountability and support system, for implementing embodiments of the present disclosure.

FIG. 1B is a block diagram of the back-end server support system, for implementing embodiments of the present disclosure.

FIG. 2 is a flowchart diagram that illustrates the method operations performed in the user's interaction with the social accountability and support system, for implementing embodiments of the present disclosure.

FIG. 3 is an exemplary, graphical representation of a battlefield, for implementing embodiments of the present disclosure.

FIG. 4 is an exemplary, graphical representation of a civilization/barracks, for implementing embodiments of the present disclosure.

FIG. 5 is an exemplary, graphical representation of a civilization/barracks statistics report, for implementing embodiments of the present disclosure.

FIGS. 6A-G are exemplary, graphical representations of age periods that a civilization/barracks can progress through during a corresponding war, for implementing embodiments of the present disclosure.

FIGS. 7A-G are exemplary, graphical representation of user avatars, for implementing embodiments of the present disclosure.

FIG. 8 is an exemplary, graphical representation of an award page, for implementing embodiments of the present disclosure.

FIG. 9 is a block diagram of an example computer system, for carrying out the processing according to the invention.

### DETAILED DESCRIPTION

Addictions, self-doubts, chronic mental disorders and similar internal conflicts prevent a person from achieving their potential. A social accountability and support system through use of an interactive social network and gaming environment which provides social accountability and support to aid a person in conquering their addictions and internal conflicts. This is referred to herein as a social accountability and support system. Several exemplary embodiments for the social accountability and support system will now be described. It will be apparent to those skilled in the art that the present disclosure may be practiced without some or all of the specific details set forth herein.

In at least one embodiment, the social accountability and support system provides social accountability and interaction (e.g., positive peer pressure and support) and includes an online activity center were users can create an account, interact with others in structured and non-structured activities to assist each other in managing and overcoming their respective addictions and other self-defeating activities and habits. The social accountability and support system can be utilized separate from or in addition to traditional, in-person group sessions of addiction recovery programs. Further, a given individual may benefit from even more positive peer pressure and a social accountability that can be provided via the embodiments of the social accountability and support system described herein. In some instances, individuals may be able to substitute the embodiments of the social accountability and support system described herein for traditional, in-person group sessions of addiction recovery programs.

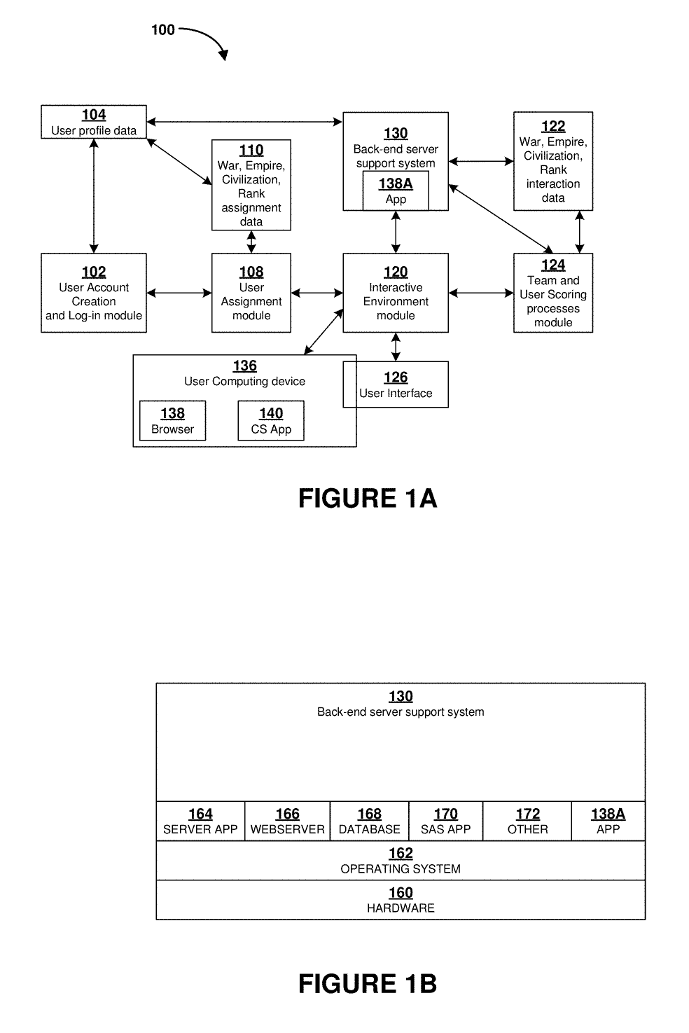

The attached figures provide an overview of the user environment and processes as a user develops desirable habits through participation in and interaction with the social accountability and support system. FIG. 1A is a block diagram of the social accountability and support system 100, for implementing embodiments of the present disclosure. The social accountability and support system 100 includes a user account module 102, a user data store 104, a user assignment module 108, a war, barracks and rank assignment module 110, an interactive environment module 120, a user interface 126, a back-end server support system 130, a user scoring processes module and a war, barracks, rank interaction data store 122.

The user account module 102 can be used for creating a new user account and logging into the social accountability and support system. Creating the new user account is referred to as enlisting in a selected war, as will be described in more detail below. The user account module 102 also provides functionality for entering and managing the user's financial data and transactions such as subscription fees and bonus redemptions, etc.

The user account module 102 also provides functionality for entering and managing the user profile data 104. The user profile data 104 identifies the user and the user's attributes such as account password, age, gender, location, contact information, billing information, user history, avatar selection and other user preferences for use of the social accountability and support system 100. At least a portion of the user profile data 104 can be stored in a server support system 130. Another portion of the user profile data 104 can be stored and managed locally, such as in a computing device 136 the user uses to access the social accountability and support system 100.

The social accountability and support system 100 also includes a user assignment module 108. The user assignment module 108 assigns the user to a selected war, empire within the selected war, civilization within the selected empire and initial rank within the civilization. The user's assigned war, empire, civilization and initial rank are stored and updated in the user profile data 104. In one or more implementations, the user can be automatically assigned to the war, empire, civilization and initial rank based on the user profile data. Alternatively, or additionally, at least a portion of the user assignment to the war, empire, civilization and initial rank can be manually selected by the user and/or a moderator of the social accountability and support system 100. The user assignment data is stored in the war, empire, civilization and rank assignment data store 110. In at least one implementation, at least a portion of the war, empire, civilization and rank assignment data store 110 can be included in the server support system 130. In at least one implementation, at least a portion of the war, empire, civilization and rank assignment data store 110 can be included in the computing device 136 the user uses to access the social accountability and support system 100. The users can be assigned to different wars according to user preference or the addiction, self-doubt, chronic mental disorder or other aspect of the user wishes to change.

The back-end server support system 130 includes a server environment for managing, hosting and delivering the interactive environment module 120 for the social accountability and support system 100. The user interface 126 displays the interactive environment for the users to interact with the social accountability and support system and interact with other users within the social accountability and support system and receives the user inputs from the user and communicates the user input data to the back-end server support system 130. In at least one implementation, the user interface 126 receives content data from the back-end server support system 130 and the interactive environment module 120 and presents the content data as an interactive environment to the user via the computing device 136 the user uses to access the social accountability and support system 100. In at least one implementation, the user interface 126 receives user inputs from the user and delivers the user input data to the back-end server support system 130 and the interactive environment module 120.

In at least one implementation, the user interface 126 can be hosted on the back-end server support system 130 and accessed via a browser 138A or another suitable server-based application. In at least one implementation, the user interface 126 can be hosted on the computing device 136 the user uses to access the social accountability and support system 100. In another implementation, the user interface 126 can be hosted on a combination of the back-end server support system 130 and the computing device 136 the user uses to access the social accountability and support system 100.

The user input data can also be captured in the war, empire, civilization and rank interaction data store 122. The user input data can also be used in the user scoring module 124 to update user scoring and interaction data, as will be described in more detail below. The modules of the social accountability and support system 100 are interconnected and transfer various data and information for use as will be described in more detail below.

In at least one implementation, the social accountability and support system 100 can also include a Conquered. Self application (CS App) 140 that can be installed on any suitable user computing device 136 e.g., computer, tablet, smartphone or other user device, capable of accessing the social accountability and support system 100. The CS App 140 can include the user interface 126 and provide substantial or significantly limited processing of the user inputs to the user device. The CS App 140 can pass the user input data to the social accountability and support system 100 for further processing. The CS App 140 can also receive information and data from the social accountability and support system 100 in response to the user inputs and corresponding to processes conducted by the social accountability and support system. In at least one implementation, the user computing device 136 can include a browser 138 or similar application for accessing and interacting with the social accountability and support system 100

FIG. 1B is a block diagram of the back-end server support system 130, for implementing embodiments of the present disclosure. The back-end server support system 130 includes a computer hardware layer 160, an operating system layer 162, a server application 164, a webserver application 166, the webserver database manager and database 168 for managing the webserver data, the optional browser application 138A, a social accountability and support application 170 and other applications and functionality 172, as may be needed.

The computer hardware layer 160 includes all necessary computer devices such as a CPU, data buses, I/O devices, volatile and non-volatile memory devices, mass storage, communication devices such as network cards and similar communication devices. The operating system layer 162 operates and communicates with the hardware layer 160. The applications 138A, 164-172 utilize the operating system 160 to act as an intermediary for using the hardware layer 160 to perform the desired computing and communication functions. One or more of the applications can include virtual layers and virtual machines for optimizing communications and data exchange with devices external to the back-end server support system 130. The server application 164 receives and manages data server requests from external devices such as the user interface 126. The web server application 166 manages and delivers webpage data (e.g., HTML, XML, CSS, etc.) as may be requested and generated by the social accountability and support system 100. The social accountability and support application 170 includes the modules 102-124 and can optionally include at least a portion of the user interface 126.

In at least one exemplary implementation, the social accountability and support application 170 includes a Ruby on Rails, or similar, application for generating the required responses to the user inputs received from the user interface 126. By way of example, a webpage is transmitted to the user interface 126. The user interacts with the webpage on the user interface 126 such as completing a form page or entering a comment on a forum page. The user input data is communicated to the social accountability and support application 170 which can use the received user input data to modify the existing webpage being served to the user interface or send a new webpage to the user interface, for the user to interact with next.

At least a portion of the user interface 126 is hosted on the user's computing device 136, such as a dedicated CS App 140, or through browser 138. The user's computing device 136 maintains a session with the social accountability and support application 170 using session management protocols such as cookies and similar session identifier and status management systems.

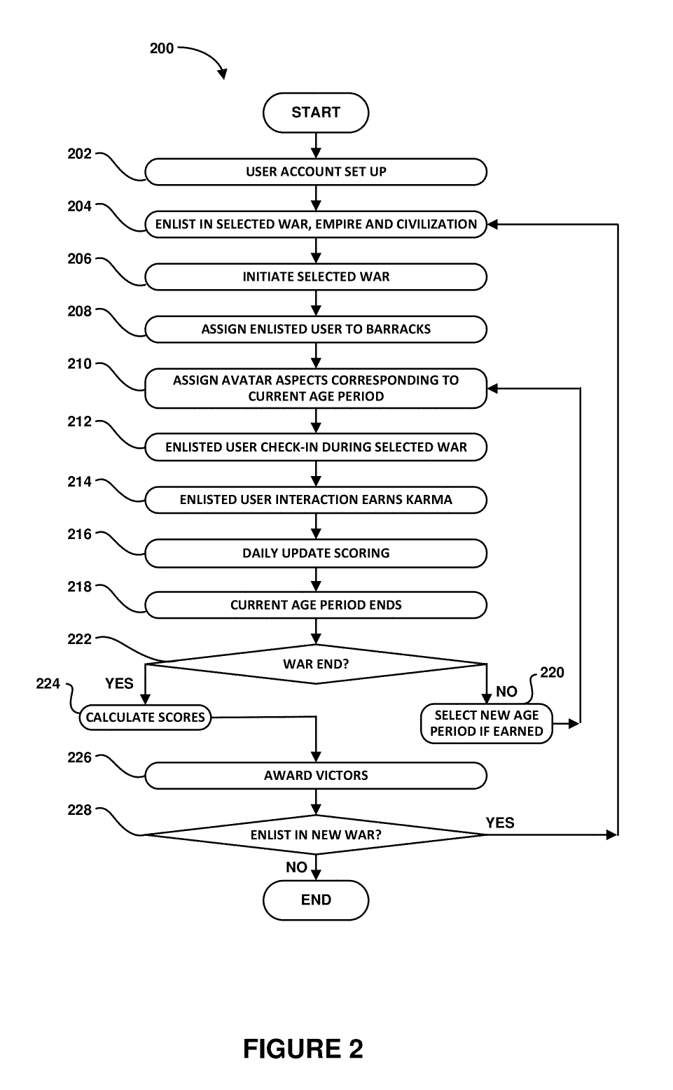

FIG. 2 is a flowchart diagram that illustrates the method operations 200 performed in the user's interaction with the social accountability and support system 100, for implementing embodiments of the present disclosure. The operations illustrated herein are by way of example, as it should be understood that some operations may have sub-operations and in other instances, certain operations described herein may not be included in the illustrated operations. With this in mind, the method and operations 200 will now be described.

In an operation 202, the user sets up an account as described above and in the attached drawings. The user can select a user name, password and set the user preferences for notifications and data sharing and more. Users can also invite others to participate in the social accountability and support system 100 by sending an invitation as part of setting up user account.

In an operation 204, the user selects a war to enlist in. Each war is designed to help the user overcome a difficulty in the user's life such as an addiction or correct a bad habit. A non-exhaustive list of examples of types of wars that can be participated in the social accountability and support system 100 include a no alcohol war, a no drugs war, a no sex war, a no pornography war, a no smoking war, a no social network war, an exercise war, a diet war, a no procrastination war and a meditation war. The specific events and interactions of each war will be customized to the user and the goal in overcoming the difficulty in the user's life. Each war has rules that define the required user interactions for the war. By way of example, the rules can specify daily (or more or less often) check-ins and other enlisted interactions such as participation on the forums within the enlisted war and in the discussion threads. The rules can also define what constitutes a killed in action (KIA) and a missing in action (MIA). The rules can also include what is required to earn user bonuses and how to advance or fail as an enlisted user and how to advance or fail for the enlisted user's civilization/barracks. The rules can also include other features that define when, where and how the enlisted user interacts with the social accountability and support system 100 and the other users, civilizations/barracks, empires and wars in the social accountability and support system.

Once enlisted in a war, the user is now an enlisted user. The user will usually enlist at some time before the war begins. This provides an opportunity for other users to enlist in the same war. The war will have at least 2 sides. A first side and an opposing second side. As described above, one or more empires can be included in each of the first side and the second side. When the time for the war to begin arrives, then the war is initiated in an operation 206.

Either when the war is initiated or before the war is initiated, the enlisted users are assigned to the respective empires and civilizations/barracks, in an operation 208. In at least one implementation, the user's profile data and personal history will be utilized to assign the enlisted users in corresponding empires and civilizations/barracks. In one implementation, at least a portion of the enlisted users are randomly assigned to their respective civilizations/barracks. In another implementation, at least a portion of the users are assigned to their respective civilization/barracks having one or more multiple influencers for corresponding to the specific support needs of each enlisted user. The multiple influencers can include personal motivation, structural motivation, social motivation that provides personal and social accountability, rewards, helps users develop the skills and abilities to overcome their challenges and provide coaching to help the enlisted user to succeed. The specific assignment of the enlisted user in the respective empires and civilizations/barracks is performed to provide the greatest success at user engagement and interaction. This enhances the enlisted users' interaction with the selected war and thus increases the likelihood of success for the individual, enlisted user and their respective empires and civilizations/barracks.

In an operation 210, the enlisted users are assigned a corresponding avatar. The corresponding avatar includes aspects corresponding to the age period of the war. In this instance, as the war is just beginning, the age period will be the first age period of the war. In later age periods of the war, the aspects of the avatars will have additional features and enhancements.

In an operation 212, the enlisted user interacts with the social accountability and support system 100. The enlisted user interactions include check-ins, posting in discussion forums and threads, posting artistic expressions (e.g., words, phrases, poems, songs, music, photos, drawings, paintings, etc.) that the enlisted user finds appropriate to express themselves in their enlisted war.

The enlisted user's interactions are rewarded with karma points and other awards such as bonuses, medals and trophies. The user's current karma points are updated in real time, as soon as the user has earned the karma points. On the barracks or civilization page, a user can view his or her karma level which is calculated based on their forum activity. By way of example, in one implementation, a user may be awarded one karma point for liking a comment in a thread in a battlefield or civilization/barracks discussion forum. Similarly, the user may earn an additional two karma points for creating a thread, and/or posting a comment in an existing thread. Conversely, the user may lose one or more karma points for every 24 hours the user is inactive (i.e., missing in action (MIA)). Users within the top selected percentage (e.g., 10%) of users with the greatest numbers of karma points at the end of the war may be awarded a prize such as a free or discounted war or a trophy. The enlisted user's interactions can also assist the corresponding barracks to attaining the goals for the current age period and the war and thus assist the corresponding barracks in achieving barracks awards such as building bonuses, medals and trophies. In an operation 216, a daily scoring update is performed to update the scoring for achievements for each of the civilizations/barracks and each empire in the war. By way of example, the daily update will show the progress of a civilization/barracks toward attaining an age goal of the next age period. Similarly, an empire's scores will be updated in the daily update to show the empire's current status in the war. The daily update could be performed in periods greater than or less than once per day. If a user attempts to post to a forum or access a civilization/barrack page during the daily update, the user may be delayed in receiving the requested page and may receive a place-holder page that is incomplete or an error page or a maintenance/update page. Refreshing the page after the daily update is completed will cause an updated page with the latest civilization/barracks and/or empire scores and statistics. The individual scoring and civilization/barracks and empire scoring functions are performed by the user and team scoring processes module 124 of the social accountability and support system 100.

The more the enlisted user interacts with the social accountability and support system 100, the more positive, reinforcing feedback the enlisted user receives. The interaction—feedback process tends to increase the enlisted user's engagement with the social accountability and support system and ultimately, aids in instilling and maintaining the enlisted user's new habit and overcoming enlisted user's difficulty (e.g., addiction, bad habit, mental illness or compulsion, etc.).

As the war continues in time, the current age period ends in an operation 218. As described above, each age period can be any portion of the duration of the war. In a simple example implementation, the war has a duration of seven weeks (49 days) where each age period corresponds to one week and then the war has seven age periods. It is important to note that the age periods can have different durations from one age period to another and can be longer or shorter than one week (7 days) and that wars can have a longer or shorter duration than 49 days.

Many different actions can occur when the current age period ends. The end of the current age period actions can include awarding and promoting the barracks for their successes and not rewarding or promoting the barracks if they did not achieve one or more the goals and objectives of the current age period. The enlisted users can also receive awards and promotions based on their individual achievement in the current age period. Alternatively, the enlisted users may not receive awards or promotions based on failure to achieve goals. The age goals are awarded, or not awarded in cases where the age goals are not met, during the daily update as described in operation 216 above.

The current age period is examined in an operation 220. If the current age period is not the last age period in the war, then a subsequent age period is selected in an operation 222 and the war continues in operations 210-218, as described above.

If the current age period is the last age period in the war, then the method operations continue in an operation 224 where the empires are scored and winners are identified. In an operation 226, the victorious empire(s) are awarded with completion awards. Individual enlisted users in the victorious empire(s) can also be awarded in various forms and their user profiles are updated with their corresponding successes and experiences. In at least one implementation, operation 226 can also include, recognizing the non-victorious empire(s) and assigning corresponding recognition awards. Individual enlisted users in the non-victorious empire(s) can also be awarded in various forms and their user profiles are updated with their corresponding successes and experiences.

In an operation 228, the user is able to choose to enlist in a new war. In one implementation, the user can be limited to enlisting in only one war at a time. In other implementations, the user can enlist in more than one concurrent war. If the user chooses to enlist in a new war, the method operations continue in operation 204, as described above. If the user chooses to not enlist in a new war, the method operations can end.

The war represents a period of time during which the user interacts with their peers. The war is an online multiplayer competition hosted by the social accountability and support system 100. Depending on the addiction, self-doubt, chronic mental disorder or other aspect of the user wishes to change category e.g., no alcohol no smoking fitness meditation, etc. Whenever a user signs up for the category, the user enlists in a war for that category. The user then enters a team-based competition with other users that are enlisted in the same war. After enlistment and after the war begins, the total users are divided into two main teams also known as empires. In at least one implementation, each empire includes four subteams referred to as civilizations. Each civilization is assigned to a corresponding barracks. It should be understood that more or less than four subteams could be included in each empire. The enlisted users are assigned to one of the civilizations, depending upon the population size.

The goal of the war is to win the war by having the most individual users successfully following the specific rules of the war. Individual users could win the war, alternatively an empire or a civilization could win the war. To win the war, individually, or as an empire or a civilization, the user must consistently participate in the war for the time period of the war by following the rules of the war. The competition is about which empire or civilization has the highest number of consistently participating users at the end of the war. The consistently participating users are referred to as active-duty, enlisted users.

In at least one implementation, the time period of the war is 49 days. The 49 day time period of the war is based on psychological research evidence of positive habit-forming is developed over a period of approximately 49 days. It should be understood that the time period of the war could be greater or less than 49 days.

Each enlisted user checks-in according to a schedule portion in the rules for the corresponding war. The check-in confirms habit execution based on the rules of the war the user is currently enlisted in. The check-ins facilitate active, daily participation and engagement from the user towards the user's fellow enlisted users in the same civilization in the currently enlisted war.

The user can also receive a user reward for regularly checking-in. The user reward assists the users' development of positive habits overcoming the addiction, self-doubt, chronic mental disorder or other aspect of the user wishes to change by regularly reinforcing desired user behavior. The user rewards for checking-in can include, for example, a motivational quote, an insightful quote, a video, an avatar upgrade, an individual medal and/or civilization/barracks-based rewards. The user rewards help motivate each of the other users to continue to check-in. By way of example, upgrading the user's avatar can increase the user's interest in the war as each avatar has a corresponding motivational story.

The civilization/barracks can also receive civilization/barracks awards such as building bonuses and/or barracks upgrades. Civilization/barracks awards can be awarded to civilization/barracks that have the most check-ins or the most consistent check-ins by the individual users in the respective civilization/barracks. The civilization/barracks awards can also be earned by civilization/barracks group behavior such as interactions and discussions in the battlefield.

The frequent check-ins also help the user consciously and mindfully impact the daily statistics of the user's civilization/barracks' performance in the currently enlisted war. As a result, the user develops a personal, emotional stake and therefore begins to care more and more about the user and the other members of the user's civilization/barracks performance in the currently enlisted war.

The user's care about the other members of the user's civilization/barracks performance leads to greater social accountability, and as a result, improves every user's consistency rate. The frequent check-ins provide a balanced approach of user participation in the war so as to be not too frequent to get boring or annoying and not too disparate in time to dilute the war's excitement, novelty, and competitiveness, or so that the user might forget about the war altogether. A check-in can include many different types of activities ranging from a minimum of logging into the war to requiring some sort of data entry such as a journal posting to the battlefield or a response to post made by one or more other members of the user's civilization/barracks to requiring any other sort of positive habit reinforcing type of activity. In one implementation, the user can check-in simply by clicking or selecting a “Check-In” button or similar button such as at the beginning of the current war the user is enlisted in. The check-in confirms the desired habit execution. The user's status as checked-in is updated in real time. The user's checked-in scoring for the user's civilization/barracks may not be immediately updated and may be delayed until a daily update occurs to update the scores for the empires and civilizations/barracks.

The frequency of the check-in process can include any suitable schedule, for example: rules for a given war may specify users check-in once every calendar day, once every hour, once every 30 minutes, once every few hours, once every 24 hours, once every two days, once every week or any other suitable check-in frequency.

The frequency of the check-ins can also vary according to various factors. For example, during a first portion of the war (e.g., the first three, five or seven days of the currently enlisted war), check-ins may be required every 3 hours. During a second portion of the war (days 4-14 of the currently enlisted war) check-ins can be gradually extended to once per day. During a third portion of the war (e.g., days 15-end), the check ins can be required once every 60 hours.

The check-ins may vary in frequency based on events of the war. For example, if another member of the user's civilization is reported killed in action (KIA) due to a relapse, the check-in frequency may be increased from the current frequency to twice as often or some other suitable, selected increase in frequency. In another example, the war may enter an increased activity period or increased stressful period and the check-in frequency is also increased to assist the user in participating in the war. The user check-ins could also be automated for the user's convenience for a portion of or the entire war.

The check-in frequency can be determined by the type of war. In one type of war where the behavior sought to be changed is very frequent, the check-ins frequency can be correspondingly frequent. In other types of wars where the frequency of the behavior sought to be changed is less frequent, the check-ins may be correspondingly less frequent. By way of example in a learning to meditate war where the desired goal is 30 minutes of meditation per day, the check-in frequency could initially be once per day and gradually decrease in frequency. In another example of a very frequent behavior war, such as a no smoking war may require more frequent check-ins of once every 30 minutes because smoking is a very frequent habit/addiction. As the no smoking war progresses and the enlisted user is successful at not smoking, the no smoking war can gradually extend the periods of time between check-ins. In at least one implementation, the time periods between check-ins can be individualized to each enlisted user. By way of example, in a no smoking war, if a first enlisted user was successful in not smoking, then the first user's check-ins could be extended from an initial check-in frequency of every 6 hours to once per day and then to once every 2 days. Conversely, a second enlisted user in the no smoking war that was not consistently successful at not smoking, may have their check-in frequency increased from the initial once every 6 hours to once every 90 minutes. Further, if a user relapses, the check-in frequency can be increased. The check-in frequency is specified in the rules for the respective war and the examples provided here in are merely examples and do not limit the variations in the enlisted users' check-in frequency.

Users also report killed in action (KIA) when the user relapses during the war. A relapse is when the user reports they have fallen back into their addiction or bad habit or otherwise are no longer participating in the war, e.g., drops out, stops participating, excessive numbers of missed or late check-ins, etc. or any other KIA status as defined by the rules of the particular war.

In at least one implementation, there are two empires in each war. However, it should be understood that more than two empires could be assigned to each war. The empires assigned to a war are competing against each other. By way of example, a first empire opposes a second empire in the same war. In alternative implementations, multiple empires can be allied together and included in a corresponding side of the war.

Each empire can contain one or more sub-divisions referred to as civilizations. The civilizations reside in corresponding barracks. In one implementation, there can be four civilizations in each empire. The four civilizations are allies to each other because the four civilizations are part of the same empire. It should be understood that the civilizations on one side of the war are opponents of all the civilizations on the opposing side of the war.

One civilization or barracks can rank higher or lower than other barracks in their empire. The war includes a competition between the barracks within each Empire as well, as to which civilization is upgraded to the next age period, which civilization won the building bonus each period of the war (e.g., each week or each variable length portion of the war), which civilization is currently in first place etc.

Users can gain more karma points than other members of the user's civilization. Karma points correspond to participation level and/or commitment to the civilization. In one implementation, users from a first civilization can appear stronger due to having an age period upgrade, as indicated by an upgraded or new avatar, that users from a second civilization have not yet accomplished. Age period upgrades are a civilization-based reward and thus is not a direct reflection of individual user performance.

Over a period of time, users who have successfully completed a war may be further identified with a star badge or similar indicator next to their names where more wars completed is indicated by having more star badges or indicators. The star badges help users differentiate themselves in the battlefield forums when they post a thread/comment. Users can also earn individual trophies based on their war success rate, and based on how many wars they have participated in. In one implementation, there can be additional subdivisions of the civilizations. In at least one implementation, the individual trophies and badges and other user specific awards are awarded during the periodic (e.g. daily update process) described above, as part of calculating the scores at the end of the war.

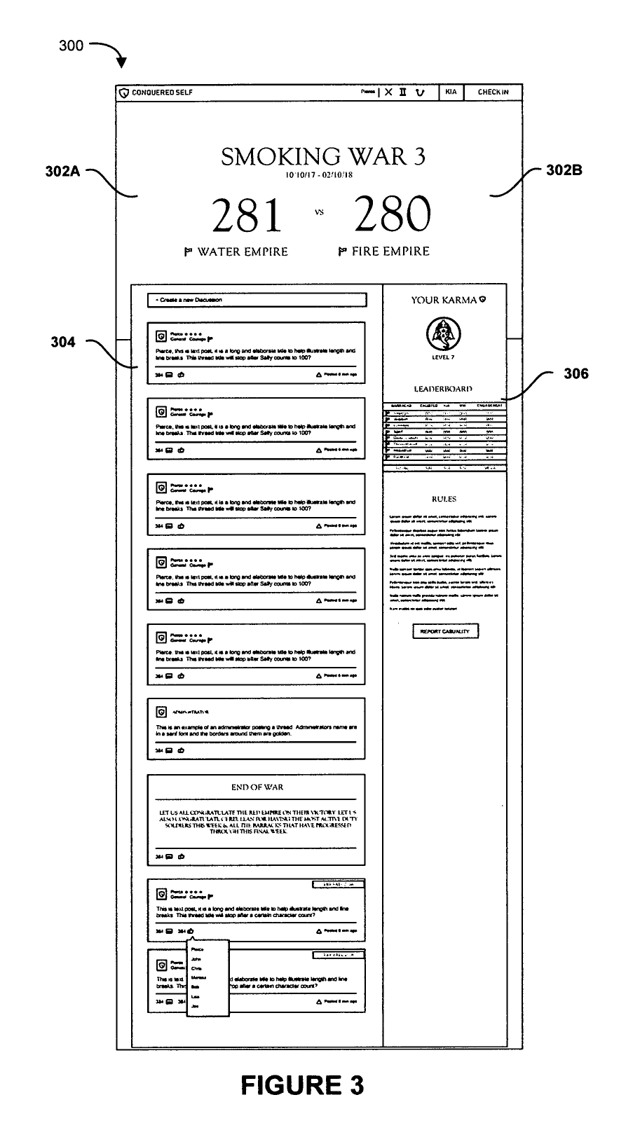

The social accountability and support system 100 also includes a virtual battlefield for each war. The battlefield is the main thrum area where users enlisted in the corresponding war can interact with each other such as posting threads and comments. The battlefield is operated by the interactive environment module 120. FIG. 3 is a graphical representation of a battlefield 300, for implementing embodiments of the present disclosure. The “Water Empire Vs Fire Empire” anti-smoking war is illustrated in the battlefield 300. The battlefield 300 includes a score and the latest forum entries for the users to post responses to or add new posts to as part of their interaction in the War, The battlefield 300 is also a page where users land after enlisting in the corresponding war and wait for the war to start. Civilization and barracks pages are created as part of initiating the war.

The top of the battlefield page shows the number of active duty soldiers for each empire 302A, 302B. An active duty soldier is an enlisted user assigned to a civilization within the respective empire and that satisfies the active duty requirements specified by rules of the corresponding war between the empires 302, 302B. These numbers of active duty soldiers represent, in real time, which empire is currently winning and thus helps maintain a sense of competition and team spirit among the users. The interaction forum 304 is provided for the enlisted users to interact with each other in posting a new forum posts, reacting to a forum post (e.g., liking, disliking, etc.), or posting a comment to an existing forum post or any other suitable activity. The statistics 306 on the right show all the civilizations/barracks and their respective order is constantly changing based on the number of active duty soldiers in each civilizations/barracks. The red or blue flags beside civilizations/barracks names help the user identify ally and enemy civilizations. Due to the empire and civilizations/barracks relationship, users have multiple layers of team spirit, social accountability and sense of achievement. By way of example, a user that is part of the Patience civilization/barracks can gain a sense of achievement by either motivating his or her civilization/barracks members to improve the civilization/barracks ranking or by going beyond their civilization/barracks and motivating ally civilization/barracks members to improve empire statistics as a whole. The user could also just focus on his or her performance and not care too much about the civilization/barracks or empire statistics. These are important in the gamified social accountability features to improve user habit consistency rate for all users. The battlefield page can also include a report casualty button for self-reporting a user as KIA. The social accountability and support system 100 relies on users' honesty in the war. It is expected the user self-report KIA when he or she fails to follow the rules during in particular day of the war.

Enlisted users are the total number of users that have signed up for e.g., enlisted in) a selected war. A total enlisted users (enlisted soldiers) include KIA soldiers+MIA soldiers+active duty soldiers. Active duty soldiers include enlisted users that are still “alive” in the war as indicated by satisfying the rules for the war for check-ins and other required activities. The number of active duty soldiers varies day to day based on how many soldiers relapse or get KIA. MIA soldiers are soldiers that are overdue for check-in or other bases for corresponding to the rules of the corresponding war. MIA soldiers can automatically become MA soldiers if the MIA soldiers fail to correct their MIA status within a given time period specified in the war rules. In one implementation, an MIA soldier can be automatically designated as MA if the MIA soldier does not check-in within 24 hours. KIA soldiers are those that have broken any of the rules of their specific war category, or relapsed on their addiction, self-doubt, chronic mental disorder or other aspect the user wishes to change. The KIA notification feature improves social accountability via social embarrassment and via not letting down other members of the user's civilization.

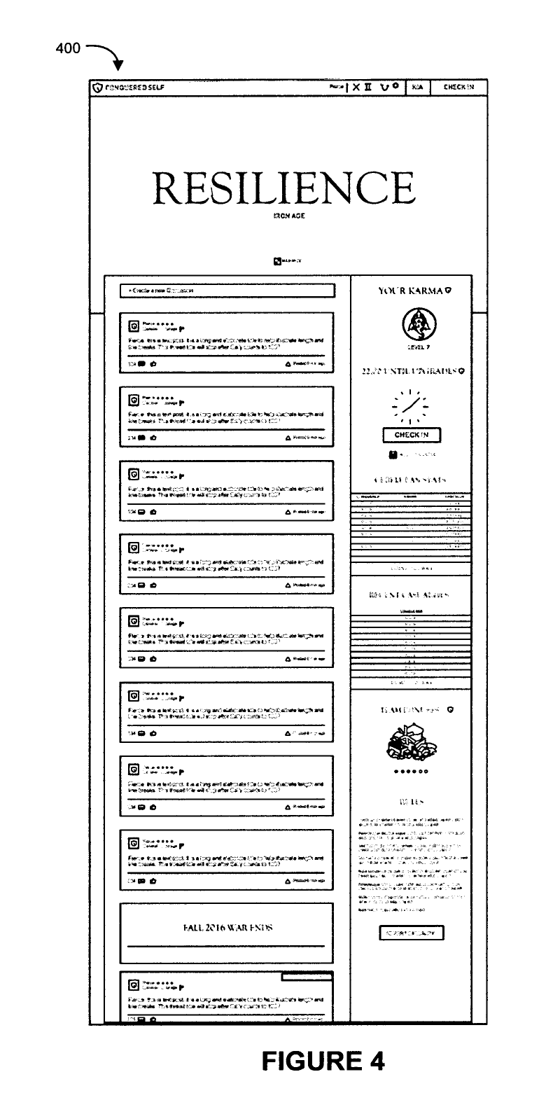

FIG. 4 is an exemplary, graphical representation of a civilization/barracks 400, for implementing embodiments of the present disclosure. Each civilization e.g., Resilience, Strength, Wisdom, Courage, etc.) has their own unique barracks. For example, the Resilience barracks is where all the soldiers from the Resilience civilization reside, interact or otherwise hangout. The civilization/barracks page is somewhat similar to the battlefield page. The civilization/barracks page is a more intimate forum area limited to those soldiers enlisted in that particular civilization/barracks. The civilization/barracks page can also include a user's karma level, the user names of the soldiers that belong to the civilization/barracks including their respective status (e.g., MIA, KIA, active duty, etc.). The civilization/barracks page also shows any civilization/barracks bonus awards or building awards that a civilization could earn each age period of the war such as, if the civilization meets or exceeds a goal such as an active duty soldier interaction and activity criteria for a respective age period of the war. The civilization/barracks page could also show additional information about the civilization/barracks such as the past performance data of the civilization/barracks in the current war and future age goals and progress toward future awards such as the next ager goal or a next building award or other awards and goals the civilization/barracks is working toward.

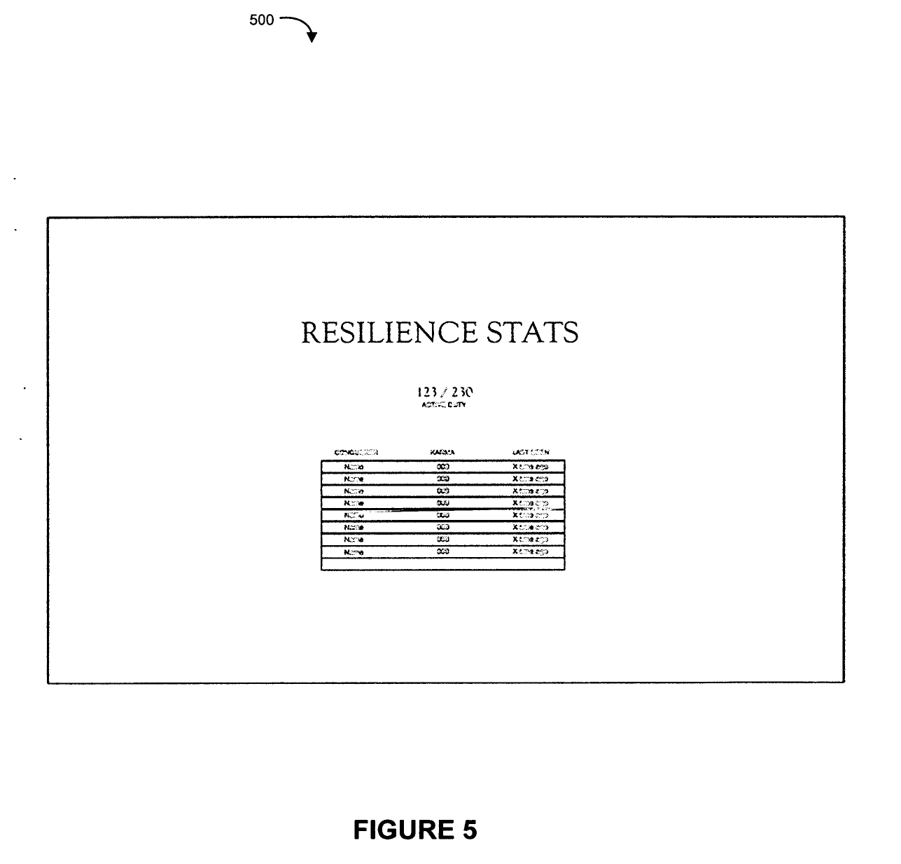

FIG. 5 is an exemplary, graphical representation of a civilization/barracks statistics report 500, for implementing embodiments of the present disclosure. The civilization/barracks statistics report 500 shows the current statistics for each user assigned to the civilization/barracks. In this way, the other members of the civilization/barracks can readily identify the other members of the civilization/barracks that need more assistance and motivation to help the civilization/barracks and empire win the war.

The social accountability and support system 100 also includes different “age periods.” The different age periods help to integrate a subtle storyline to the avatar transformation. A selected portion of each war (e.g., a week or other portion of the war) represents an age period of time or simply an age period. The goal of successfully completing each age period of the war provides age goals for each civilization. The age periods are shorter time periods than the time period of the war. The accomplishment of attaining each age goal can be rewarded with building bonuses, upgraded barracks, new set of avatars. The age goal rewards can unlock additional storylines and/or capabilities for the evolution of the avatar and/or civilization.

The concept of ages periods and age goals helps maintain user interest and participation as users can have a sense of achievement before the end of the war and the winning civilization are announced. The age period and age goal concepts also allow users to be excited and competitive every corresponding portion of the war, thus allowing users to have multiple ways to have a sense of achievement throughout the entire time period of the war.

The concept of age periods and age goals can also provide age goals toward the overall goal at the end of war. Earning an upgrade to the subsequent age period requires civilization based active duty criteria to be met each age period, the age goal of the upgrade to the subsequent age period constantly applies pressure on the users to be consistent and not relapse for members of the user's civilization. One user's relapse could negatively impact the entire civilization. Thus, if all the civilization members are positively influenced by the age goals, then at the end of the war at least selected percentage (e.g., 60% or some other preselected percentage or other performance criteria) of the enlisted users in that civilization might have succeeded in completing the goal of remaining active the entire time period of the war.

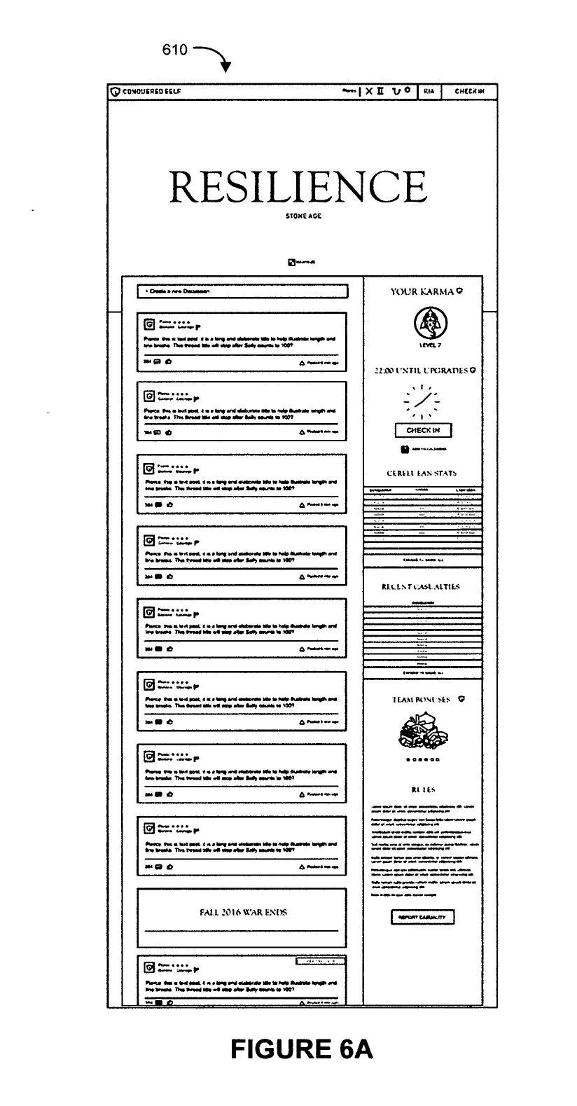

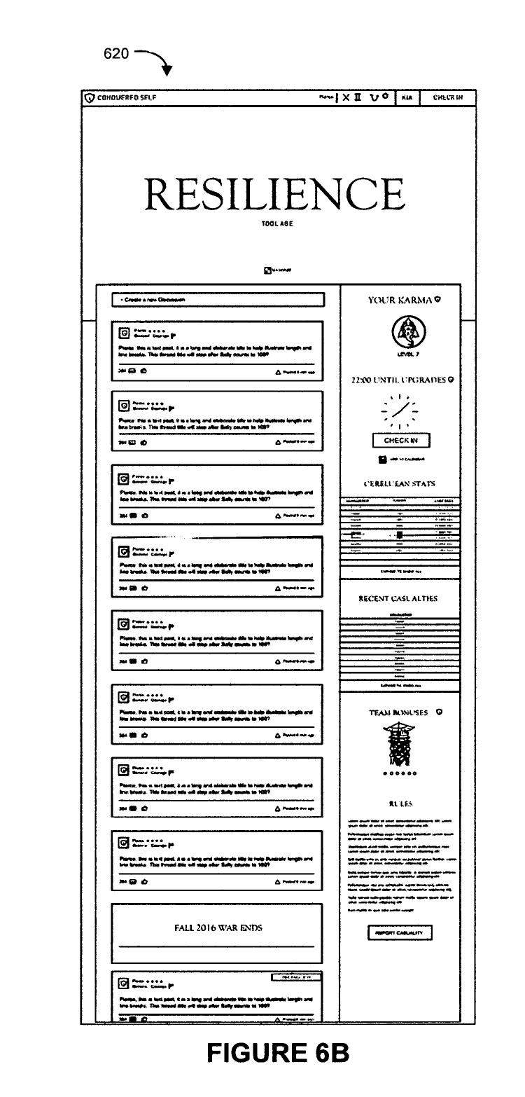

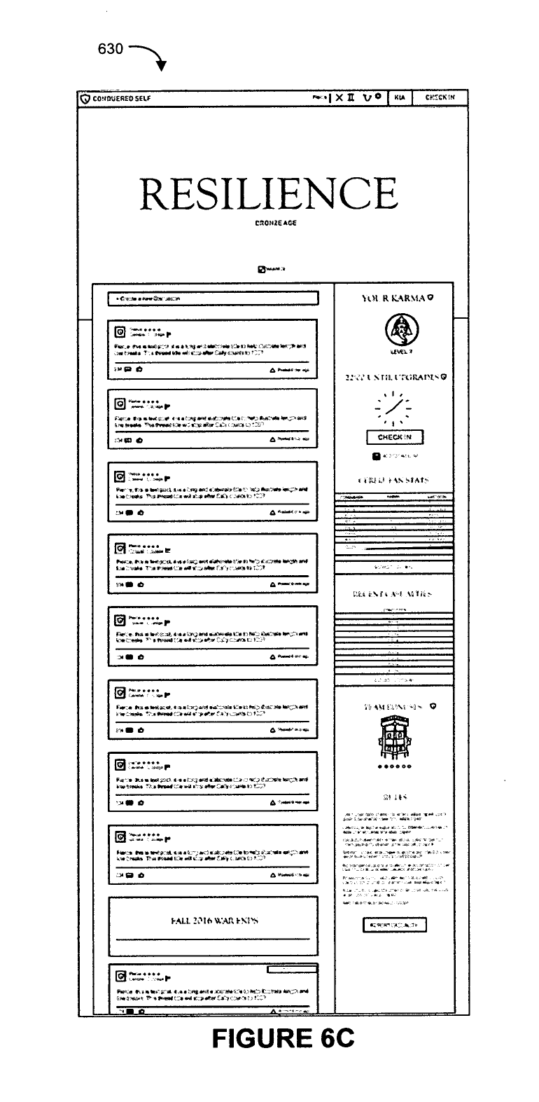

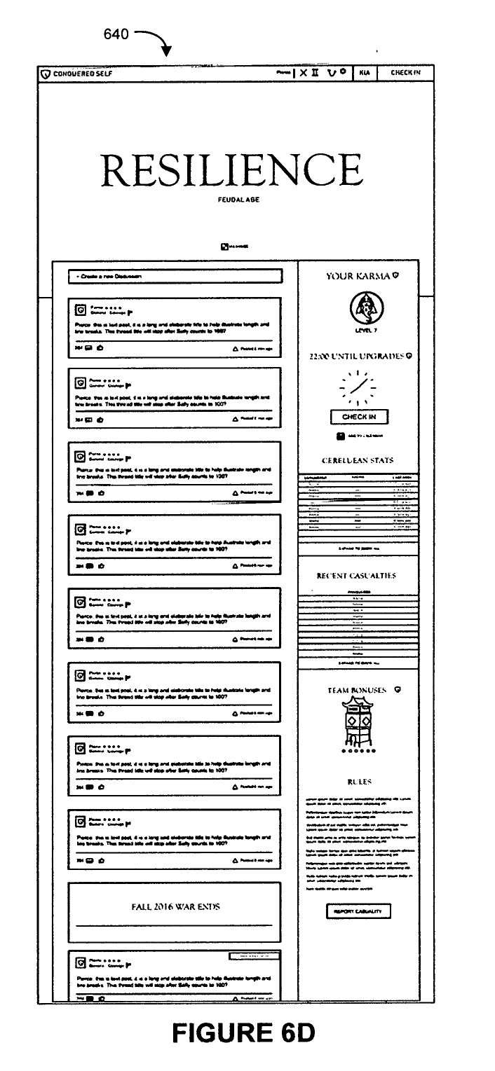

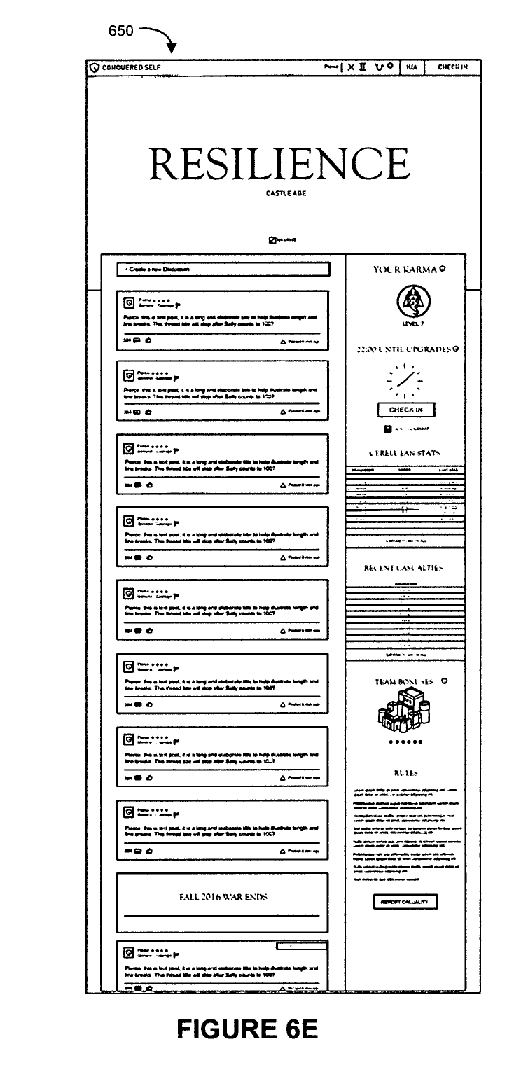

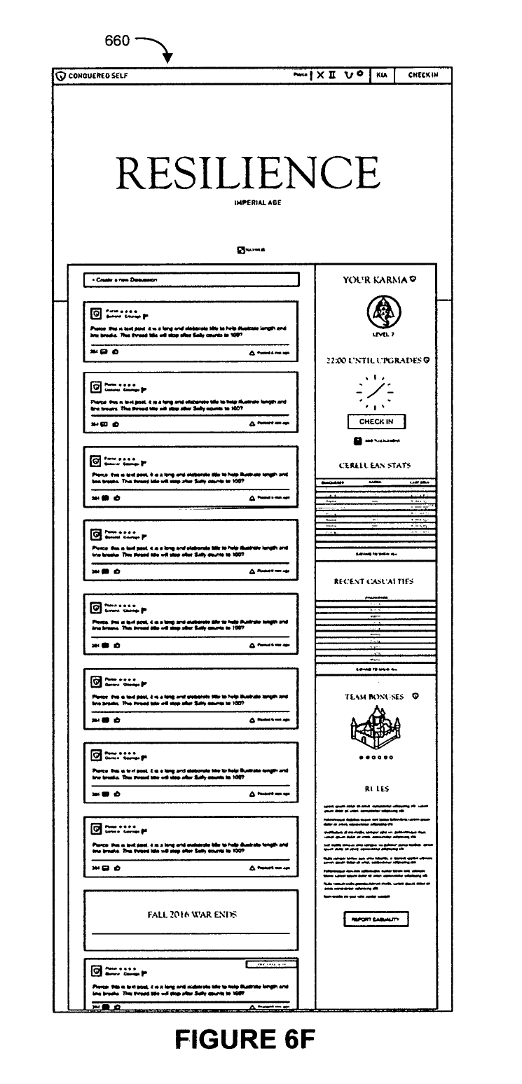

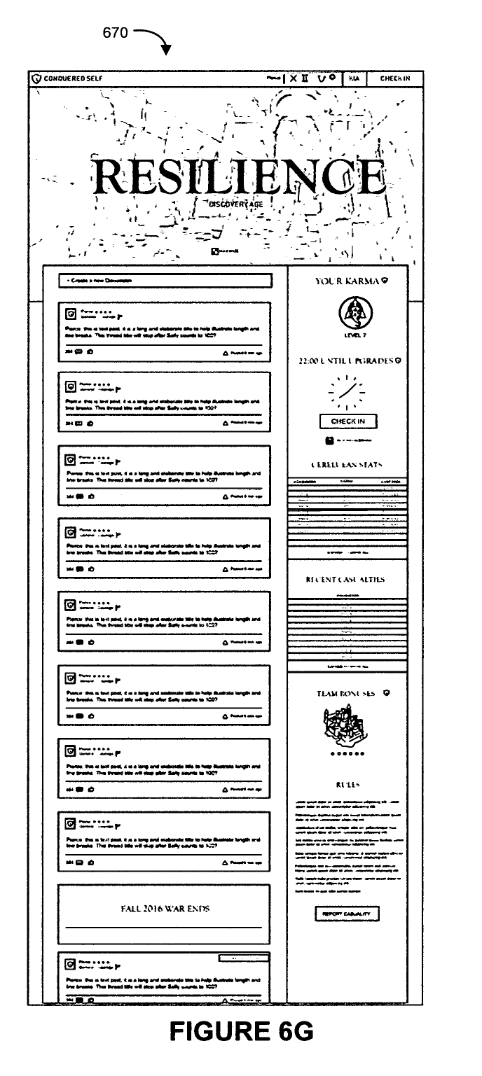

FIGS. 6A-G are exemplary, graphical representations of age goals 610-670 that a civilization/barracks can progress through during a corresponding war, for implementing embodiments of the present disclosure. As the days of the war progress, the age periods can evolve and become clear until the day in which the new age period is earned. FIG. 6A is a 100% blurred state of the Tool Age 610 as the initial representation of the Tool Age goal. As the civilization/barracks reaches the time and performance goals to earn the upgrade to Tool Age goal, the Tool Age goal is revealed in more clarity. The criteria required to earn each subsequent age period advancement is specified in the rules for the war. By way of example, the civilization/barracks may be required to obtain at least a 90% active duty status for the first age period to gain advancement to a second age goal for a second age period. If the civilization/barracks fails to earn the second or subsequent age goal the users maintain the same civilization/barracks cover page and the avatars of the active duty soldiers may be frozen and not evolve to newer avatars. The civilization/barracks may be required to repeat the current age period before being able to earn the subsequent age period. Continuously failing to earn the next age goal is a great risk that the civilization/barracks and their respective empire may lose the war. This earning a new age period feature places a high emphasis on social accountability within the civilization/barracks. The user's performance can impact his or her civilization/barracks evolution during the war and as a result there is a higher motivation and peer pressure for the user to stay on track and not relapse as evidenced by their daily checking-in. This earning a new age goal for a subsequent age period feature also cultivates a healthy competition, differentiation and novelty among the different civilization/barracks and their respective enlisted users.

FIG. 6B illustrates a Bronze Age 620 such as may be seen as a second age goal in the war. In one implementation, the second age goal can be earned if the civilization/barracks has maintained at least an 85% of the civilization soldiers as active-duty status during the current age period. When a civilization/barracks upgrades to a new age period, the respective enlisted users may also receive upgraded avatars, as described in more detail below.

FIG. 6C illustrates an Iron Age 630 such as may be seen as a third age goal in the war. In one implementation, the third age goal can be earned if the civilization/barracks has maintained at least an 80% of the civilization soldiers as active-duty status during the second age period.

FIG. 6D illustrates a Feudal Age 640 such as may be seen as a fourth age goal in the war. In one implementation, the fourth age goal can be earned if the civilization/barracks has maintained at least an 75% of the civilization soldiers as active-duty status during the third age period.

FIG. 6E illustrates a Castle Age 650 such as may be seen as a fifth age goal in the war. In one implementation, the fifth age goal can be earned if the civilization/barracks has maintained at least an 70% of the civilization soldiers as active-duty status during the fourth age period.

FIG. 6F illustrates an Imperial Age 660 such as may be seen as a sixth age goal in the war. In one implementation, the sixth age goal can be earned if the civilization/barracks has maintained at least an 65% of the civilization soldiers as active-duty status during the fifth age period.

FIG. 6G illustrates a Discovery Age 670 such as may be seen as a seventh age goal in the war. In one implementation, the seventh age goal can be earned if the civilization/barracks has maintained at least an 60% of the civilization soldiers as active-duty status during the sixth age period.

It should be understood that fewer or more than seven age periods can be implemented in a given war and that the time period for each age period can be the same or different or even varying according to the rules of the corresponding war. The percent active duty criteria described above are merely one example implementation and different percentages of active duty soldiers and other enlisted user activity can be required by the civilization/barracks members to earn the new age period. In one implementation the top two civilizations having the greatest numbers of active duty soldiers at the end of each age period can earn an upgrade to the next age period. Conversely, the civilizations other than the top two civilizations do not earn an upgrade to the next age period and are set to remain in their current age period for a subsequent age period of time.

Avatars provide users with another sense or aspect of progress in the war. Humans participate in role playing games and/or television shows and/or movies, at least in part, because games, television shows and movies progress faster than real life. In real life to become good at something, a typical human must spend several months and possibly even years. In contrast, in a game, a television show or a movie a character can develop very quickly. By way of example, a full year's worth of training at the gym can be compressed into a 1 minute montage in a movie. This is why games, television shows and movies can sometimes be more motivational than looking at our own real lives.

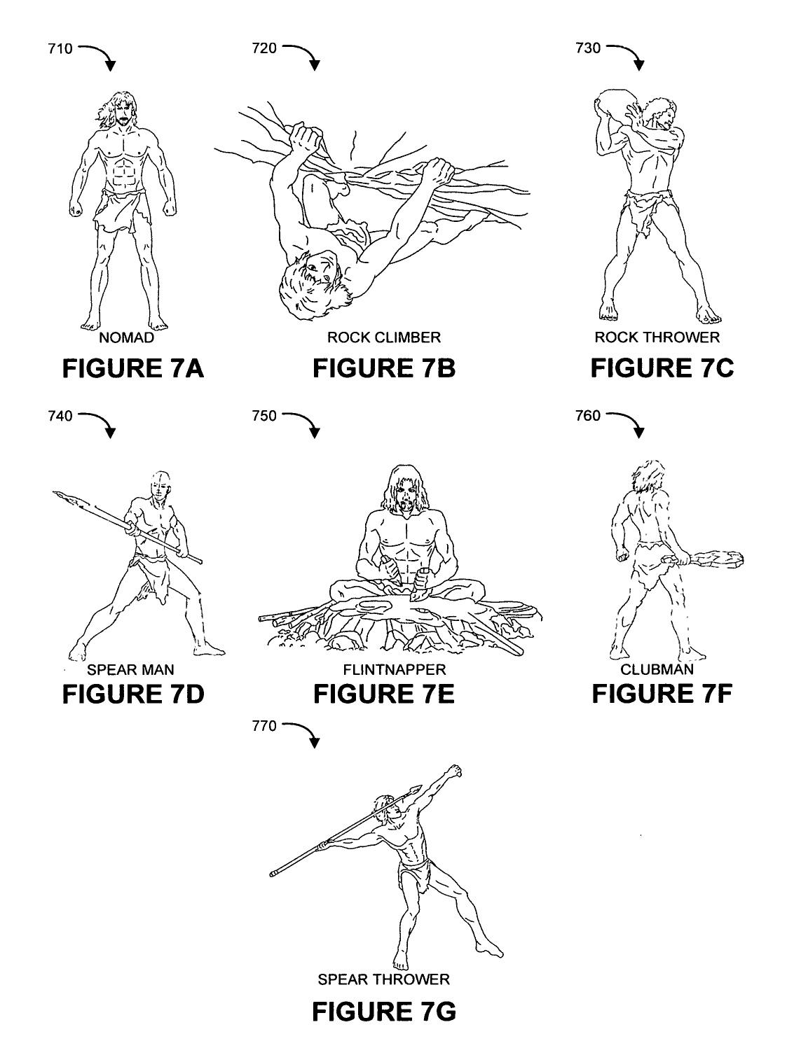

FIGS. 7A-G are exemplary, graphical representation of user avatars 710-770, for implementing embodiments of the present disclosure. The avatar evolution helps make the process of everyday user check-in more interesting, worthwhile and fun for the user. Users will want to endure and participate and check-in to see the unfolding of their avatar's story.

The time period of the war can be any suitable length. In one implementation, the war last 49 days. 49 days is a relatively long time for most people. 49 days is not usually enough to provide significant tangible/visible benefits. However, in the social accountability and support system war, the user's avatar is significantly evolving and possibly growing stronger on a daily basis. The avatar's evolution follows a logical, systematic pattern. The avatar's evolution is supported with a storyline similar to a movie or a television show. By seeing the avatar's progress, users can relate to the avatar and derive a sense of progress and inspiration at a faster rate.

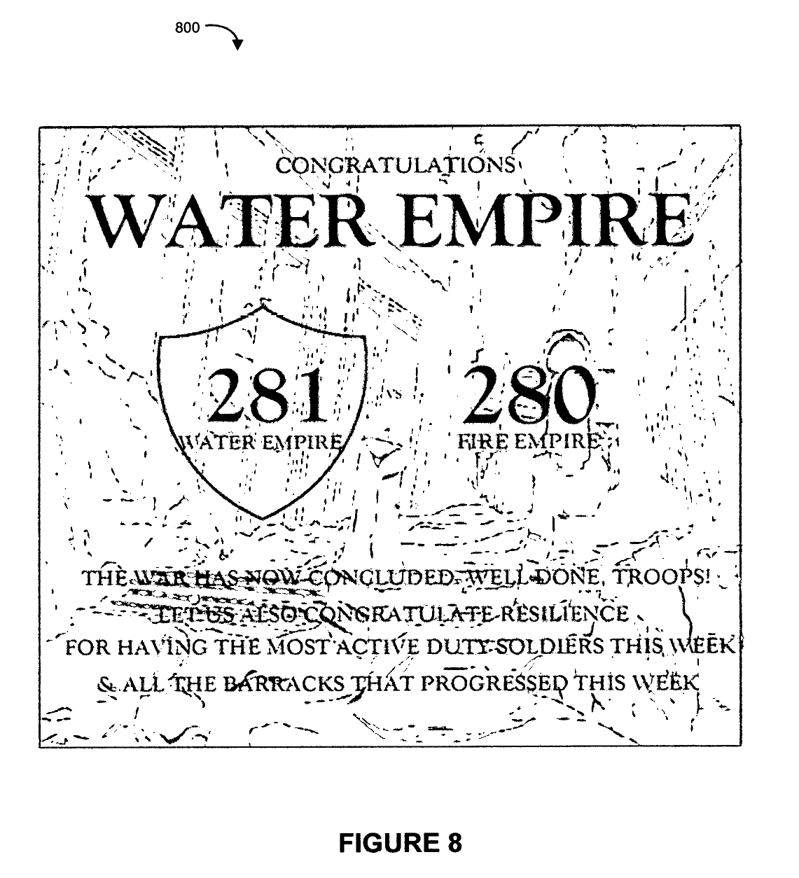

FIG. 8 is an exemplary, graphical representation of an award page 800, for implementing embodiments of the present disclosure. The empire, e.g., Water Empire, with the highest score wins the war. Medals can be awarded to reward early wins and further reinforce desired behavior. Trophies can be awarded to reward individual user performance and customer loyalty. Example trophies can include things such as a free or discounted war for a selected percentage of the war survivors with highest Karma points. The trophies encourage such users to come back to the social accountability and support system 100 because their high karma is a reflection of how much they contribute towards the social accountability and support system community. Having them on board for the next war will be an asset for the entire social accountability and support system community

Building Bonus are awarded to a civilization in each age period of the war. The building bonus is shown in the barracks page. The building bonus is awarded for having the highest number of active duty soldiers. Each age period the building bonus earned is better than the previous age period. The building bonuses can correspond to the age period, The building bonus feature contributes towards weekly competition. The bragging rights that a barracks/civilization earns by attaining an age goal will fuel the determination of other barracks/civilizations to do better as team in attaining subsequent age goals. Such healthy competition positively contributes towards the overall user graduation rate at the end of the war.

Avatar evolution pattern describes how the users' avatars improve physically (e.g., strength and muscle mass), mentally (e.g., skill acquisition, exploration and learning), and Spiritually (e.g., meditation, and enlightenment) as the days progress and as the age period upgrades occur.

Quotes and videos are carefully curated to not only provide motivation, but also provide insightful knowledge on life and multiple types of self-improvement in general. The quotes and videos can be supplementary in nature. The quotes and videos can be used to help a user's motivation for the day that they're about to embark on. The quotes and videos can sometimes be meant to help the user realize other areas of life the user might improve on.

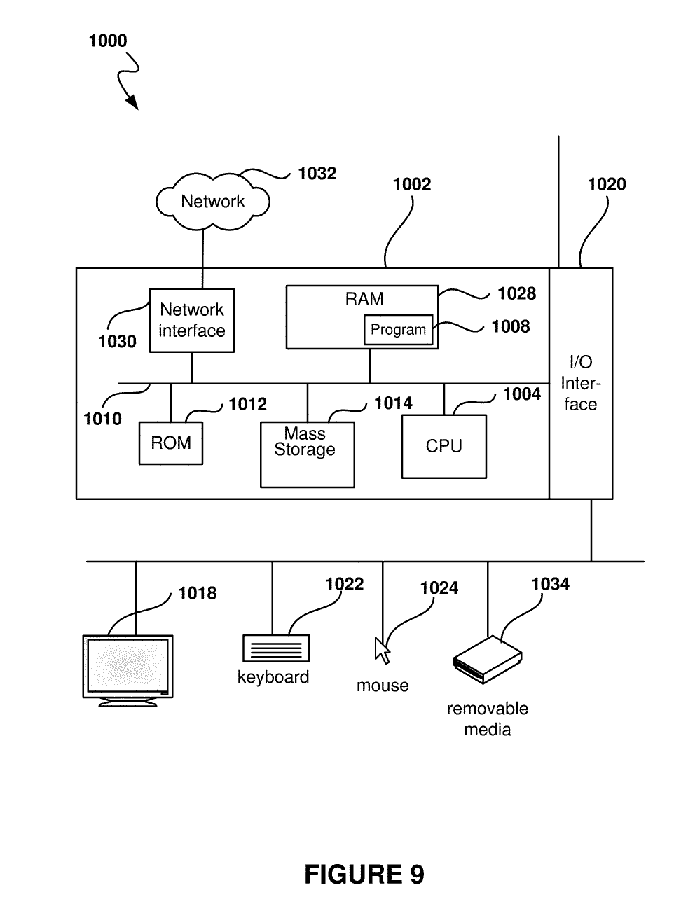

FIG. 9 is a block diagram of an example computer system 1000 for carrying out the processing according to the invention. A general or specialized computer system, such as the computer system 1000, can be used as a controller for controlling a system executing the operations for performing at least a portion of the analyses described above. The computer system 1000 includes a computer 1002, a display 1018, an optional printer or output device (not shown), a removable media (e.g., magnetic/optical/flash) drive 1034, a mass storage system 1014 (e.g., hard disk drive, solid state drive, or other suitable data storage device), a network interface 1030, and a keyboard 1022. Additional user interface devices such as a mouse 1024, a touch pad or touch screen can also be included.

The computer 1002 includes a central processing unit (CPU) 1004, one or more data buses 1010, random access memory (RAM) 1028, read only memory (ROM) 1012, and an input/output interface 1020. The computer 1002 can be a personal computer (such as an IBM compatible personal computer, a Macintosh computer or Macintosh compatible computer), a workstation computer (such as a Sun Microsystems or Hewlett-Packard workstation), a server or some other suitable type of computer.

The CPU 1004 can be a general purpose digital processor or a specially designed processor. The CPU 1004 controls the operation of the computer system 1000. Using instructions retrieved from memory (e.g. program(s) 1008), the CPU 1004 controls the reception and manipulation of input data and the output and display of data on output devices.

The data buses 1010 are used by the CPU 1004 to access the RAM 1028, the ROM 1012 and the mass storage 1014. The RAM 1028 is used by the CPU 1004 as a general storage area and as scratch-pad memory, and can also be used to store input data and processed data. The RAM 1028 and the ROM 1012 can be used to store computer readable instructions or program code 1008 readable and executable by the CPU 1004 as well as other data.

The bus 1010 can also be used to access the input, output, and storage devices used by the computer 1002. These devices include the display 1018, the optional printer (not shown), the removable media drive 1034, and the network interface 1030. The input/output interface 1020 is used to receive input from keyboard 1022 and send decoded symbols for each pressed key to CPU 1004 over the data bus 1010.

The display 1018 is an output device that displays images of data provided by the CPU 1004 via the bus 1010 or provided by other components in the computer system 1000. The optional printer device, when operating as a printer, provides an image on a sheet of paper or a similar surface. Other output devices such as a plotter, projector, etc. can be used in place of, or in addition to, the printer device.

The removable media drive 1034 and the mass storage 1014 can be used to store various types of data. The removable media drive 1034 facilitates transporting such data to other computer systems, and mass storage 1014 permits fast access to large amounts of stored data. The mass storage 1014 may be included within the computer system or may be external to the computer system such as network attached storage or cloud storage accessible over one or more networks (e.g., local area networks, wide area networks, wireless networks, Internet 1032) or combinations of such storage devices and locations. The mass storage 1014 can include any one or more combinations of any suitable types of storage media including magnetic media, optical media, solid state, non-volatile memory devices, flash memory and any other suitable type of read and writeable media readable and writeable by the CPU 1004.

The CPU 1004 together with an operating system operate to execute computer readable code and logic and produce and use data. The computer code, logic and data may reside within the RAM 1028, the ROM 1012, or other integrated circuits such as within a portion of the processor, an application specific integrated circuit or other programmable logic array that can be utilized to express the computer code, logic and data, and/or the mass storage 1014 or other media storage devices and combinations thereof. The computer code and data could also reside on a removable program medium and loaded or installed onto the computer system 1000 when needed. Removable program media include, for example, DVD, CD-ROM, PC-CARD, floppy disk, flash memory, optical media and magnetic disk or tape.

The network interface 1030 is used to send and receive data over a network 1032 connected to other computer systems. The network interface 1030 can include an interface card or similar device and appropriate software implemented by the CPU 1004 can be used to connect the computer system 1000 to an existing network and receive and transmit data according to standard and specialized protocols such as local area networks, wide area networks, wireless networks, Internet and any other suitable networks and network protocols to and from other computers. The network interface 1030 can also be used to link multiple computers such as in a data center or a server network.

The keyboard 1022 is used by a user to input commands and other instructions to the computer system 1000. Other types of user input devices can also be used in conjunction with the present invention. For example, pointing devices such as a computer mouse, a track ball, a stylus, touch pad, touch screen or a tablet can be used to manipulate a pointer on a screen of a general-purpose computer.

The computer system 1000 can be one or multiple servers that can be coupled to one or more wired and/or wireless networks and ultimately coupled to a user device. The user device can be any suitable user device including a computer, similar to the computer system 1000, or a mobile computing device (e.g., telephone, tablet, smartphone, and similar computing devices, etc.). The user device provides the user access to and the capability to interact with the social accountability and support system 100. The user device can also include one or more portions of the social accountability and support system 100 such as a user interface and a communications interface (e.g., application programming interfaces (APIs) that allow the user device to communicate with the social accountability and support system. It should also be understood that while the described embodiments cover conventional gaming type interface, the social accountability and support system 100 can also be implemented in a virtual and/or augmented reality type of user interface/user interaction using virtual and/or augmented reality hardware and corresponding computer applications.

It will be further appreciated that the instructions represented by the operations in the above figures are not required to be performed in the order illustrated, and that all the processing represented by the operations may not be necessary to practice the invention. It should also be appreciated that some operations may have sub-operations and in other instances, certain operations described herein may not be included in the illustrated operations. Further, the processes described in any of the above figures can also be implemented in software stored in any one of or combinations of the RAM, the ROM, or the hard disk drive.

With the above embodiments in mind, it should be understood that the disclosure may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

The disclosure may be practiced with other computer system configurations including hand-held devices, microprocessor systems, microprocessor-based or programmable consumer electronics, minicomputers, mainframe computers and the like. The disclosure may also be practiced in distributing computing environments where tasks are performed by remote processing devices that are linked through a network.

With the above embodiments in mind, it should be understood that the disclosure may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the disclosure are useful machine operations. The disclosure also relates to a device or an apparatus for performing these operations. The apparatus may be specially constructed for the required purpose, such as a special purpose computer. When defined as a special purpose computer, the computer can also perform other processing, program execution or routines that are not part of the special purpose, while still being capable of operating for the special purpose. Alternatively, the operations may be processed by a general purpose computer selectively activated or configured by one or more computer programs stored in the computer memory, cache, or obtained over a network. When data is obtained over a network the data maybe processed by other computers on the network, e.g., a cloud of computing resources.

The embodiments of the present disclosure can also be defined as a machine that transforms data from one state to another state. The transformed data can be saved to storage and then manipulated by a processor. The processor thus transforms the data from one thing to another. Still further, the methods can be processed by one or more machines or processors that can be connected over a network. Each machine can transform data from one state or thing to another, and can also process data, save data to storage, transmit data over a network, display the result, or communicate the result to another machine.

The disclosure can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, DVDs, Flash, magnetic tapes, and other optical and non-optical data storage devices. The computer readable medium can also be distributed over a network coupled computer systems so that the computer readable code is stored and executed in a distributed fashion. The computer readable medium can also include logic embodied in an integrated circuit such as within a portion of a microprocessor, an application specific integrated circuit or other programmable logic array that can be utilized to provide non-volatile logic that can embody one of more portions of the processes described herein and can then be used by the processor for performing the processes.

It will be further appreciated that the instructions represented by the operations in the above figures are not required to be performed in the order illustrated, and that all the processing represented by the operations may not be necessary to practice the disclosure. Further, the processes described in any of the above figures can also be implemented in software stored in any one of or combinations of the RAM, the ROM, or the hard disk drive.

Although the foregoing disclosure has been described in some detail for purposes of clarity of understanding, it will be apparent that certain changes and modifications may be practiced within the scope of the appended claims. Accordingly, the present embodiments are to be considered as illustrative and not restrictive, and the disclosure is not to be limited to the details given herein, but may be modified within the scope and equivalents of the appended claims.

What is claimed is:

1. A system for interacting with a user comprising:
an interactive environment providing a mental and emotional challenge and rewards for a user wherein the interactive, multi-user environment;
a feedback output specifically tailored to address a user and the user's defined desired goal;
a measurement system for measuring a success rate for the user; and
a feedback modifier for adjusting the feedback to improve the success rate of the user.

2. The system of claim 1, comprising:
an enlistment module;
an interactive environment module for hosting an interactive war, wherein the war is divided into one or more age periods;
an assignment module;
an organizational structure of entities of varying sizes; and
a reward subsystem for rewarding users and at least one of the entities according to accomplishments of the entities.

3. The system of claim 2, wherein the organizational structure of entities of varying sizes includes at least one empire and each of the at least one empire includes at least one civilization and wherein the at least one civilization is assigned to a corresponding barracks during a duration of a war.

4. The system of claim 2, wherein the age periods include corresponding challenges and awards for the users and at least one of the entities.
